(19) United States
(12) Patent Application Publication
(10) Pub. No.: US 2022/0134523 A1
(43) Pub. Date: May 5, 2022

(54) Variable Action Floor Nailing Gun

(71) Applicant: Byron Cowan, Bridgeport, CT (US)

(72) Inventor: Byron Cowan, Bridgeport, CT (US)

(21) Appl. No.: 17/371,677

(22) Filed: Jul. 9, 2021

Related U.S. Application Data
(60) Provisional application No. 63/109,589, filed on Nov. 4, 2020.

(51) Int. Cl. B25C 1/02

(52) U.S. Cl. CPC B25C 1/02

(57) ABSTRACT

The present invention relates to an improved hardwood floor nail gun that can be used by hardwood flooring contractors to install flooring more efficiently, and with less damage to adjacent walls and other surfaces. More specifically, the improved nail gun is comprised of a number of repositionable components that allow the flooring installer to quickly and efficiently modify the orientation of the said components to satisfy user need and/or preference, or to suit a particular application. The unique and adjustable construct of the improved nail gun also ensures that the nails being used therewith are successfully installed each time regardless of the proximity of the nail gun to an obstacle, such as a wall or other structure.

### CROSS-REFERENCE TO RELATED APPLICATION

The present application claims priority to, and the benefit of, U.S. Provisional Application No. 63/109,589, which was filed on Nov. 4, 2020, and is incorporated herein by reference in its entirety.

### FIELD OF THE INVENTION

The present invention relates generally to the field of tools and other equipment used to install flooring. More specifically, the present invention relates to a hardwood floor or other flooring type nail gun that can be used by hardwood flooring contractors to install flooring more efficiently, and with less damage to walls than with conventional nail guns and tools. In one embodiment, the hardwood floor nail gun is comprised of a flexible handle that allows for the individual operating the gun to change the handle into a select one of several different potential positions, wherein each position has a different orientation relative to a nearby or adjacent wall or other limiting surface. Similarly, the nail gun device further comprises an adjustable nail rack for holding a supply of nails, and an adjustable body portion that also allows for the device to be reconfigured to a select one of several different positions or orientations relative to a nearby or adjacent wall or other structure.

Stated differently, the user of the hardwood floor nail gun of the present invention may adjust the combination of the nail rack, body and flexible handle to improve the maneuverability of the nail gun and facilitate the nailing and installation of flooring, such as hardwood flooring, even when limited operating space is available. The improved maneuverability reduces the potential damage to walls and other surfaces that surround the flooring being installed. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, many contractors and other installers of hardwood flooring currently must use multiple different types of nail guns on a flooring project. For example, a flooring installer must typically use a finish nail gun when working close to a wall or other limiting structure, and a flooring nail gun for other portions of the project. Further, installers who use only a single type of hardwood flooring nail gun may experience contact of either the nail gun or the hammer used in contact with the nail gun upon the light-strike bumper with the nearby, adjacent, or surrounding wall or surface. The contact of the external hammer or the nail gun can damage the finish of the wall. This damage increases the cost of the project, as the installer must then take the time to repair the damage, which may include patching drywall and/or touching up the paint. In addition, such damage is also a frustration for the homeowner.

Another limitation on standard hardwood floor nail guns is their rigidity in structure, which prevents the user from adjusting the orientation or position of the device to gain the necessary clearance or distance from a nearby wall or surface. More often than not, the user will be required to swing a hammer to make contact with the nail gun to actuate the same. This action oftentimes brings the hammer into contact with the nearby or adjacent wall or surface causing dents, holes, or scrapes in the plaster or drywall. A standard device with structural rigidity requires the user to swing the hammer in such proximity to the wall that the user is unable to adequately control the length of the swing of the hammer and as such the nail may not fully enter the flooring which requires the contractor to manually use a nail punch to embed the nail fully in the floor, which is both time consuming and laborious.

Yet another limitation on a standard hardwood flooring nail gun is the inability to nail flooring within corners where two walls or moldings abut. As previously stated, a standard hardwood flooring nail gun has such fixed rigidity that the user is required to swing the hammer in proximity to the walls and the user is unable to adequately control the length of the swing of the hammer, and thereby may not be able to apply enough force to fully drive or embed the nail in the floor. The user would preferably want to gain sufficient momentum to effectively hit the top of the bumper strike of the nail gun with a lengthened back swing, but is often prohibited due to the short distance or proximity of the device to an adjacent wall or other surface.

Therefore, there exists a long felt need in the art for an improved hardwood flooring nail gun. More specifically, there is a long felt need in the art for an improved hardwood flooring nail gun having a repositionable handle that enables the user to change the orientation of the handle of the nail gun to suit a particular application and avoid damages to an adjacent wall or other nearby surface. There is also a long felt need in the art for an improved hardwood flooring nail gun comprised of a repositionable nail rack that enables the user to change the orientation of the nail rack of the improved nail gun to suit a particular application and/or to satisfy user need and/or preference. Moreover, there is also a long felt need in the art for an improved hardwood flooring nail gun the use of which ensures that the nails are always properly installed in the flooring and subfloor, and that no damage is done to adjacent walls and other surfaces. Additionally, there is a long felt need in the art for an improved hardwood flooring nail gun comprised of a repositionable body portion that enables the user to change the orientation of the body portion to improve operational efficiencies, and avoid damages to an adjacent wall or other nearby surface. Finally, there is a long felt need in the art for an improved hardwood flooring nail gun that is relatively inexpensive to manufacture and that is both safe and easy to use.

The subject matter disclosed and claimed herein, in one embodiment thereof, comprises an improved hardwood flooring nail gun that has a protective body cover surrounding an aluminum pneumatic tube, an adjustable base plate, an aluminum nail rack or fastener supply and a plurality of soft grip handles. The protective body cover contains the pneumatic tube used to dispense forced air, which provides the energy to insert the nail into the flooring. At the top of the protective body cover sits the light-strike bumper which provides the contact point for an external hammer to engage the forced air pressure of the pneumatic tube, wherein said light-strike bumper is repositionable upon user demand to suit the particular application needed.

In this manner, the novel hardwood flooring nail gun device of the present invention accomplishes all of the forgoing objectives and provides the user with the ability to easily maneuver and adjust the orientation of various components on the nail gun to improve operational efficiencies and overall performance of the improved hardwood flooring nail gun device. The ability to adjust the orientation of various components of the improved hardwood flooring nail gun device of the present invention also enables the user to avoid causing unnecessary damage to nearby or adjacent walls and other surfaces, which could be both time consuming and laborious to repair, and may increase the overall cost of the flooring project.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The present invention relates to a novel flooring nail gun or flooring installation tool that is equipped with adjustable soft grip handles and an adjustable base to provide ease of use for different flooring installation angles. More specifically, the subject matter disclosed and claimed herein, in one embodiment thereof, comprises a flooring nail gun that allows a user to forcefully insert nails into the flooring to secure the flooring to the subfloor below it, while avoiding the damage to nearby or adjacent walls, molding or other surfaces. The protective cover of the body surrounds an aluminum pneumatic tube with a light-strike bumper at the top of the cover. At the bottom of the protective cover and below the pneumatic tube is a base plate which meets the flooring that is being installed. An aluminum nail rack or fastener supply, which holds multiple nails, is positioned above the base plate and is connected to the bottom of the pneumatic tube. As air is forced through the pneumatic tube, the next nail in the rack is pushed into the flooring through the force of the air.

At the top of the protective body cover and to one side of the light-strike bumper is a soft grip handle which may be adjusted to a selective one of multiple different angles relative to the body portion of the improved nail gun. The improved nail gun can also be moved into multiple different positions or orientations, which includes a first position in which the protective body cover is disposed at an angle of approximately 45 degrees to a second position in which the protective body cover is positioned an angle of approximately 90 degrees. Nonetheless, other positions and angles are also contemplated without affecting the overall scope of the present invention.

In a further embodiment of the present invention, the improved flooring nail gun device further comprises the ability to move the secondary soft grip handle from one side of the nail gun to the other if, for example, an obstruction (e.g., a wall, etc.) is present on the first side that would otherwise prevent the nail gun from being used or potentially cause damage to the obstruction. The secondary handle(s) preferably attach to the improved nail gun by means of a threaded connection, which allows the handle to be secured to the improved nail gun and quickly released as the position, orientation and/or application dictates. The threaded attachment may be molded as part of the protective body cover, though other attachment means are also contemplated to be within the overall scope of the invention including, without limitation, a snap-on or quick connection fastening means.

In a further exemplary embodiment of the present invention, a flooring installation tool is presented and includes a body that has a first end and a second end. The body includes a pneumatic tube for providing a force of air to a fastener delivery point at a second end. The first end has a strike bumper and the tool further includes a fastener supply connected to the body and at least one adjustable grip handle.

In yet a further exemplary embodiment of the present invention, an improved nail gun for installing flooring is presented. The improved nail gun includes a body portion that encloses or houses a pneumatic air cylinder. The body portion has both first and second ends, wherein the first end comprises a bumper for receiving a strike force delivered by, for example, a hammer. The second end is comprised of a base plate that is positioned on the surface of the floor. The improved nail gun many further comprise one or more adjustable grip portions that are repositionably connected to the body portion, wherein the one or more adjustable grip portions further comprise a hand grip area. Further, a fastener supply is also connected to the body portion and is movable between at least a first position and a second position.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the improved flooring nail gun device of the present invention in a first orientation in accordance with the disclosed architecture, wherein the improved flooring nail gun is about to be struck with an external hammer and is being used to install a piece of hardwood flooring to a subfloor in close proximity to a wall;

FIG. 2 illustrates a perspective view of one potential embodiment of the improved flooring nail gun device of FIG. 1 in a second potential orientation in accordance with the disclosed architecture, wherein the improved flooring nail gun is about to be struck with an external hammer and is being used to install a piece of hardwood flooring to a subfloor in close proximity to a wall;

FIG. 3 illustrates a perspective view of one potential embodiment of the improved flooring nail gun device of FIG. 1 in a third potential orientation in accordance with the disclosed architecture;

FIG. 4 illustrates a partial perspective view of a one potential embodiment of the plurality of adjustable soft grip handles of the improved flooring nail gun device of the present invention in accordance with the disclosed architecture;

FIG. 5 illustrates a partial perspective view of a one potential embodiment of the plurality of adjustable soft grip handles of the improved flooring nail gun device of the present invention in accordance with the disclosed architecture, wherein a portion of the nail rack is also depicted;

FIG. 6 illustrates a perspective view of one potential embodiment of the improved flooring nail gun device of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As stated above, there is a long-felt need in the art for an improved hardwood flooring nail gun that has one or more repositionable handles that enable the user to change the orientation of the handle of the nail gun to suit a particular application and avoid damaging an adjacent wall or other nearby surface while in use. There is also a long felt need in the art for an improved hardwood flooring nail gun comprised of a repositionable nail rack that enables the user to change the orientation of the nail rack of the improved nail gun to suit a particular application and/or to satisfy user need and/or preference. Additionally, there is a long felt need in the art for an improved hardwood flooring nail gun comprised of a repositionable body portion that enables the user to change the orientation of the body portion to improve operational efficiencies, and avoid damages to an adjacent wall or other nearby surface. Moreover, there is also a long felt need in the art for an improved hardwood flooring nail gun, the use of which ensures that the nails are always properly installed in the flooring and subfloor, and that no damage is done to adjacent walls and other surfaces. Finally, there is a long felt need in the art for an improved hardwood flooring nail gun that is relatively inexpensive to manufacture and that is both safe and easy to use.

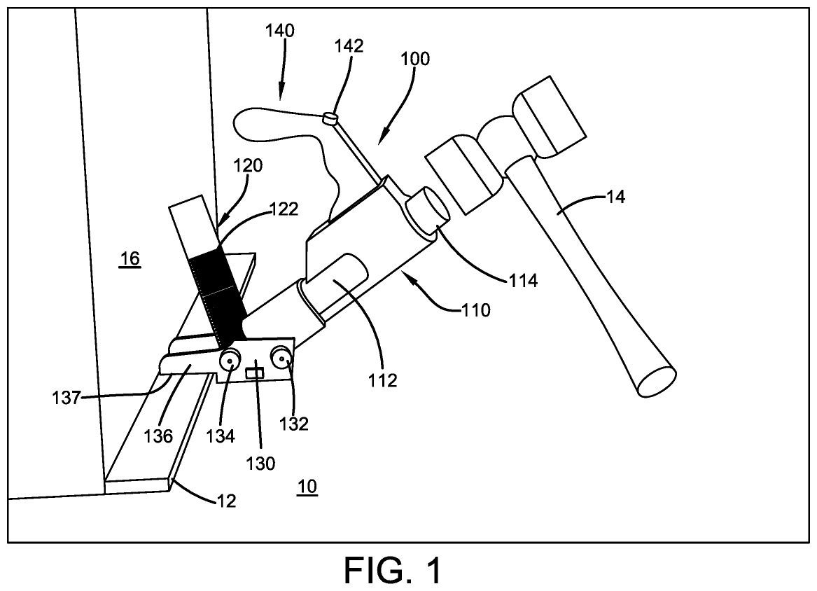

Referring initially to the drawings, FIG. 1 illustrates a perspective view of one potential embodiment of the improved flooring nail gun device 100 of the present invention in a first orientation in accordance with the disclosed architecture, wherein the improved flooring nail gun 100 is about to be struck with an external hammer 14 and is being used to install a piece of hardwood flooring 12 to a subfloor 10 in close proximity to a wall 16. The improved flooring nail gun 100 is preferably comprised of a body portion or protective cover 110, an air pneumatic tube 112, a light strike bumper or plate 114, a channel style nail rack 120, a nail rack holder 130, a base plate 136 and one or more soft grip handles 140. More specifically, in the particular orientation shown in FIG. 1, the protective cover 110 and the pneumatic tube 112 is orientated to be at an approximately 45 degree angle to the floor, which enables the light-strike bumper 114 to be positioned further away from the wall 16 to give the user additional room in which to strike the strike plate 114 without striking or damaging the wall 16. More specifically, the flooring nail gun device 100 of the present invention pivots at the main pivot point 132 to a second position to move the body 110 away from walls 16 and other surfaces or objects that can become damaged if struck by the hammer 14 (or the device 100 itself when jarred by a hammer strike).

As explained more fully below, when in use, the protective cover 110 is positioned at least partially over the pneumatic tube 112 and is preferably made from a light-weight plastic, or other suitable material that provides an ample level of protection to the pneumatic tube 112 (e.g., in the event it were accidentally struck by the hammer 112). The strike plate or bumper 114 is positioned on a first end of the body 110 and is in mechanical communication with a first end of the pneumatic tube 112, wherein the second end of the pneumatic tube 112 is in communication with a first fastener (not shown) of a plurality of fasteners 122 housed in the channel nail rack 120. In this manner, when the user strikes the strike pad 114 with a hammer 14, the strike pad 114 causes the pneumatic tube 112 to expel a burst of compressed air out of its opposite end, wherein the burst of air drives the fastener 122 into the piece of flooring 12.

The channel nail rack 120 is preferably a spring-loaded or gravity-fed nail rack that automatically advances the next nail or other fastener 122 into proper position when its predecessor has been properly driven into a piece of flooring 12 by the variable action floor nailing gun 100 of the present invention. Further, the channel nail rack 120 is preferably attached to body 110 via a nail rack holder 130 that enables the channel nail rack 120 to pivot relative to a bottom surface 137 of the base plate 136 or the flooring 10. More specifically, the channel nail rack 120 is permitted to pivot between 0 and 90 degrees (relative to the floor 10, for example) to achieve multiple different orientations, and to enable the user (not shown) to pivot the channel nail rack 120 out of the way so that it does not interfere with the workspace or wall 16. Additionally, fasteners 122 may be any fastener known in the art for application to a piece of flooring 12 such as, but not limited to, a nail, pin, staple, etc.

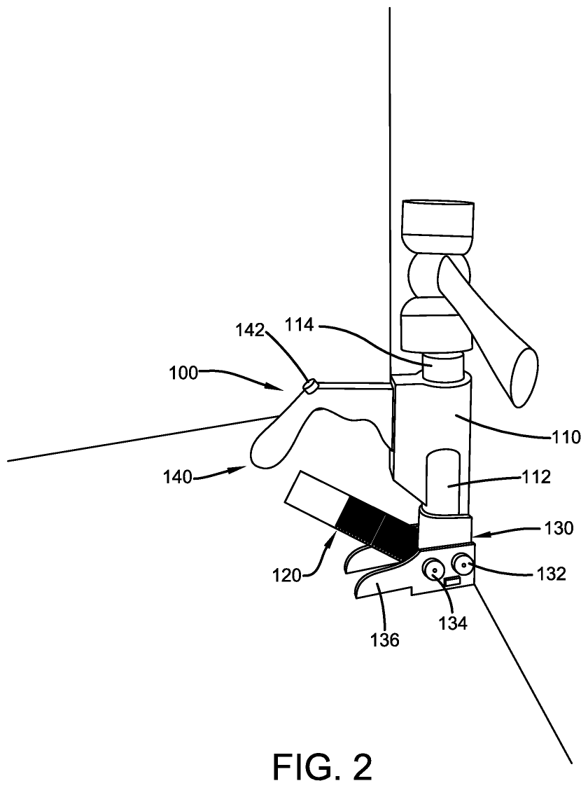

FIG. 2 illustrates a perspective view of one potential embodiment of the improved flooring nail gun device of FIG. 1 in a second potential orientation in accordance with the disclosed architecture, wherein the improved flooring nail gun 100 is about to be struck with an external hammer 14 and is being used to install a piece of hardwood flooring 12 to a subfloor 10 in close proximity to a wall 16. More specifically, the bottom surface 137 of the base plate 136 is resting on a section of hardwood flooring 12 about to be installed adjacent to a wall 16. In this particular embodiment, the body 110 of the device 100 (and hence the air tube 112) is at an approximate angle of 90 degrees (or roughly perpendicular) to the bottom surface 137 of the base plate 136 and/or the floor 10, and immediately adjacent to the wall 16.

In this manner, when the user strikes the strike pad 114 with the hammer 14, the strike pad 114 causes the pneumatic tube 112 to expel a burst of compressed air out of its opposite end and the burst of air drives the fastener 122 into the piece of flooring 12. At such time, the plurality of fasteners 122 housed in the preferably spring loaded channel nail rack 120 are automatically advanced so that the next successive fastener is immediately available to be driven into the flooring 12 by the variable action floor nailing gun 100 of the present invention. Also, in this particular orientation, the angle of the spring loaded channel nail rack 120 relative to the floor 10 is less than that which is shown in FIG. 1 as the wall 16 is no longer an obstruction, as it was in FIG. 1. Further, in each of FIGS. 1 and 2, the soft grip handle 140 extends outwardly from the front of the body 110 (i.e., in the direction of the spring loaded channel nail rack 120), as opposed to from either of its sides.

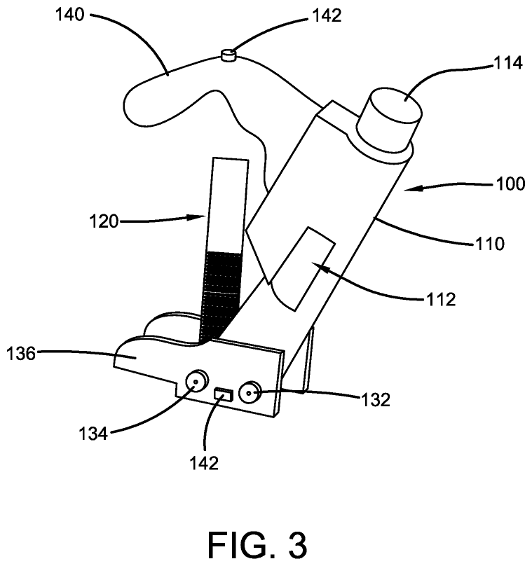

FIG. 3 illustrates a perspective view of one potential embodiment of the improved flooring nail gun device 100 of FIG. 1 in yet another potential orientation in accordance with the disclosed architecture. More specifically, in this particular orientation, the spring loaded channel nail rack 120 is positioned at an approximate angle of 90 degrees (or perpendicular) to the bottom surface 137 of the base plate 126. The body 110 and enclosed pneumatic air tube 112 of the flooring nail gun device 100 is also positioned at an angle relative to the bottom surface 137 of the base plate 126 so as to enable the user an opportunity to provide sufficient motive force to the nail gun 100 while still avoiding contact with the wall 16 or other surface or object, as the direction of the strike is roughly parallel to the wall or surface. Further, in this particular embodiment, the soft grip handle 140 again extends outwardly from the front of the body 110 (i.e., in the direction of the spring loaded channel nail rack 120), as opposed to from either of its sides.

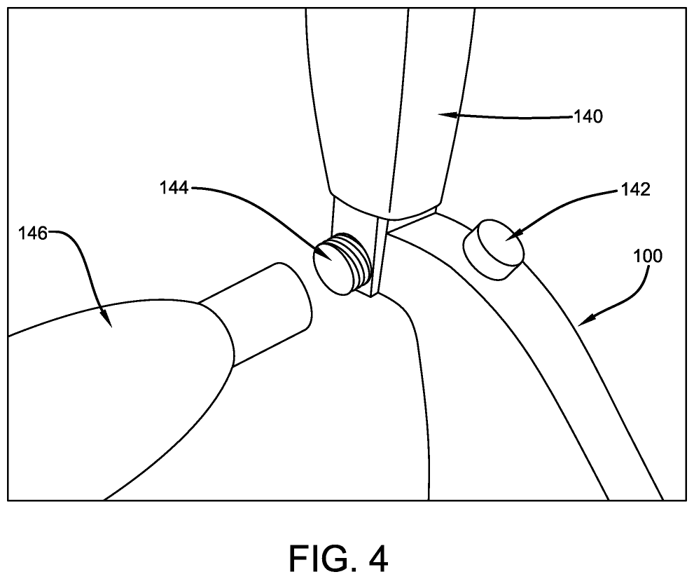

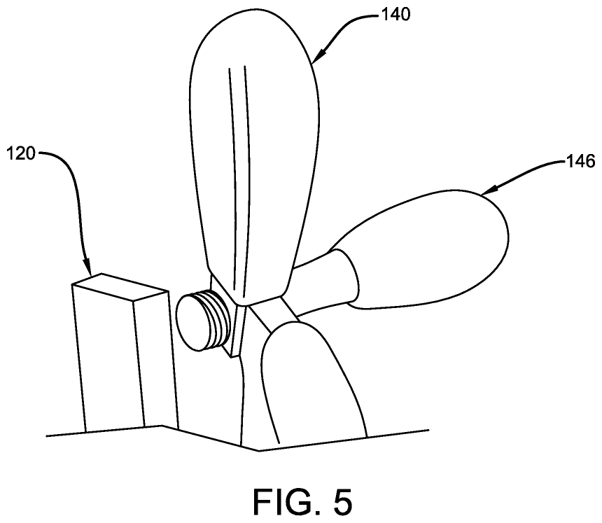

FIG. 4 illustrates a partial perspective view of a one potential embodiment of the plurality of adjustable soft grip handles 140 of the improved flooring nail gun device 100 of the present invention in accordance with the disclosed architecture. More specifically, the improved flooring nail gun device 100 of the present invention may comprise one or more adjustable soft grip handles 140 that may be removably attached to the body 110 by, for example, a threaded connector 144. The threaded connector 144 may be molded as part of the protective body cover 110, though other attachment means are also contemplated to be within the overall scope of the invention including, without limitation, a snap-on or quick connection fastening means. In FIG. 4, both first and second adjustable soft grip handles 140, 146 are being used in connection with the improved flooring nail gun device 100 of the present invention, wherein the first soft grip handle 140 extends outwardly from a front of the body 110 (i.e., in the direction of the spring loaded channel nail rack 120), and the second soft grip handle 146 is about to be removably attached to a side of the body 110 (and may be attached to either or both sides at the same time). Indeed, FIG. 5 illustrates a partial perspective view of a one potential embodiment of the plurality of adjustable soft grip handles 140, 146 of the improved flooring nail gun device 100 of the present invention in accordance with the disclosed architecture, wherein a portion of the nail rack 120 is also depicted.

As stated above, multiple components of the improved flooring nail gun device 100 are repositionable relative to the floor 10 to give the user an almost endless supply of different orientation options for the improved flooring nail gun device 100 and to allow the components to pivot about first and second pivot points 132, 134, as best shown in FIGS. 1 through 3. Further, one or more locking mechanisms 142 may be used to lock the various components (body 110, pneumatic tube 12, channel nail rack 120, soft grip handles 140, 146, etc.) into a desired position or orientation, as best shown in FIGS. 1 through 4. Locking mechanisms 142 can be any mechanism known in the art for prohibiting movement between two otherwise repositionable parts including, without limitation, a screw, pin, clamp, etc.

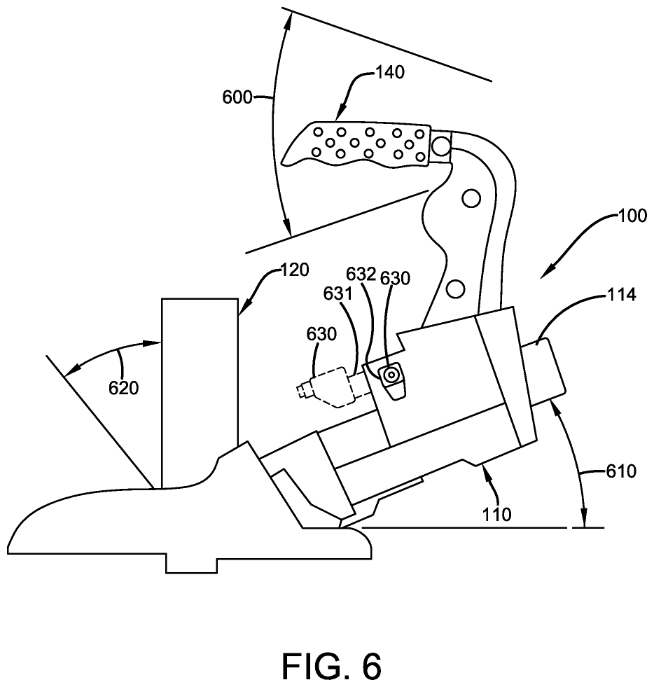

FIG. 6 illustrates a perspective view of one potential embodiment of the improved flooring nail gun device 100 of the present invention in accordance with the disclosed architecture, in which the versatility of the device 100 is on full display. More specifically, in addition to the ability to attach the handle 140 to the device 100 on multiple different sides, the device 100 has at least three pivot points. As shown, the first pivot point 600 enables the handle 140 to be rotatably repositioned to provide adequate clearance from any obstacles that may be encountered during use of the device 100, such as a wall 16. As also shown, the second pivot point 610 enables the body 110 to be rotatably repositioned to provide adequate clearance from any obstacles that may be encountered during use of the device 100, such as a wall 16. Finally, the third pivot point 620 enables the nail rack 120 to be rotatably repositioned to provide adequate clearance from any obstacles that may be encountered during use of the device 100, such as a wall 16. In a preferred embodiment of the present invention, the nail rack 120 may be rotated a total of 30 degrees, from a roughly perpendicular position relative to the floor 10 to a roughly 60 degree angle from the floor 10. Additionally, the device 100 may further comprise an air compressor connection tip 630, as best shown in FIG. 6, wherein the connector is repositionable from a first position 631 to a second position 632.

Notwithstanding the forgoing, the variable action hardwood floor nail gun 100 of the present invention and its various components can be of any suitable size and configuration as is known in the art without affecting the overall concept of the invention, provided that they accomplish the above stated objectives. One of ordinary skill in the art will appreciate that the size, configuration, and material of the variable action hardwood floor nail gun 100 and its various components as shown in the FIGS. are for illustrative purposes only, and that other configurations of the variable action hardwood floor nail gun 100 are well within the scope of the present disclosure. Although the dimensions of the variable action hardwood floor nail gun 100 and its various components (i.e., length, width, and height) are important design parameters for good performance, the variable action hardwood floor nail gun 100 and its components may be any shape or size that ensures optimal performance during use and/or that suits user need and/or preference.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flooring installation tool comprising:
a body having a first end and a second end, the body including a tube for providing a force of air to a fastener delivery point at a second end
a strike bumper positioned at the first end;
a base plate;
a fastener supply connected to the body; and
at least one adjustable grip handle, wherein the flooring installation tool further comprises a first pivot point, a second pivot point and a third pivot point.

2. The flooring installation tool as recited in claim 1, wherein the base plate is disposed at the second end of the body.

3. The flooring installation tool as recited in claim 1 further comprising a second adjustable grip handle.

4. The flooring installation tool as recited in claim 3, wherein the body is pivotable in relation to the base plate.

5. The flooring installation tool as recited in claim 1 further comprising a locking mechanism to hold the flooring installation tool in a select one of a plurality of different orientations.

6. The flooring installation tool as recited in claim 5, wherein the select one of a plurality of different orientations involves the body and the tube being at an approximate angle of forty-five degrees to a flooring surface.

7. The flooring installation tool as recited in claim 5, wherein the select one of a plurality of different orientations involves the body and the tube being at an approximate angle of ninety degrees to a flooring surface.

8. The flooring installation tool as recited in claim 3, wherein the at least one adjustable grip and the second adjustable grip are connected to the body by a threaded coupling.

9. The flooring installation tool as recited in claim 1, wherein the body pivots in relation to the base plate.

10. The flooring installation tool as recited in claim 1, wherein the fastener supply pivots in relation to the base plate.

11. The flooring installation tool as recited in claim 10, wherein the fastener supply is disposed between the base plate and the body.

12. A nail gun for installing a piece of flooring, the nail gun comprising;
a body having a first end and a second end;
a bumper for receiving a striking force from a hammer, wherein the bumper is positioned at the first end of the body;
an air cylinder at least partially enclosed in the body and in mechanical communication with the bumper;
a base plate;
a first adjustable grip removably connected to the body and having a hand grip area; and
a fastener supply containing a plurality of fasteners therein, wherein each of the fastener supply and the body are repositionable between a first position and a second position.

13. The nail gun as recited in claim 12 further comprising a second adjustable grip handle removably connected to the body.

14. The nail gun as recited in claim 12, wherein the body is pivotable in relation to the base plate.

15. The nail gun as recited in claim 12 further comprising a locking mechanism to hold the nail gun in a select one of a plurality of different orientations.

16. The nail gun as recited in claim 15, wherein the select one of a plurality of different orientations involves the body and the air cylinder being at an approximate angle of forty-five degrees to a bottom surface of the base plate.

17. The nail gun as recited in claim 15, wherein the select one of a plurality of different orientations involves the body and the tube being at an approximate angle of ninety degrees to a bottom surface of the base plate.

18. The nail gun as recited in claim 13, wherein each of the first and second adjustable grips is connected to the body by a threaded coupling.

19. A hardwood floor nailing tool comprising;
a body having a first end and a second end;
an air cylinder enclosed within the body;
a striking pad disposed on the first end of the body and in mechanical communication with the air cylinder;
a base plate disposed on the second end of the body;
a fastener supply for feeding a plurality of individual fasteners into an opening in communication with the air cylinder;
a first adjustable grip removably attached to the body via a threaded connection; and
a second adjustable grip removably attached to the body via a second threaded connection, wherein the body is repositionable relative to a bottom surface of the base plate.

20. The hardwood floor nailing tool as recited in claim 19, wherein an angle between the body and the bottom surface of the base plate can vary between 0 and 90 degrees.
